(19) United States
(12) Patent Application Publication
(10) Pub. No.: US 2024/0345251 A1
(43) Pub. Date: Oct. 17, 2024

(54) DEVICE AND METHOD FOR HAND GESTURE DETECTION

(71) Applicant: WEICHEN WANG, New Taipei (TW)

(72) Inventors: WEICHIEN WANG, New Taipepi (TW); Mong-Yu TSENG, Taipei (TW)

(21) Appl. No.: 18/631,950

(22) Filed: Apr. 10, 2024

Related U.S. Application Data
(60) Provisional application No. 63/458,329, filed on Apr. 10, 2023.

(51) Int. Cl. G01S 17/89; G01S 7/481; G06F 3/01

(52) U.S. Cl. CPC G01S 17/89; G01S 7/4813; G01S 7/4817; G06F 3/014; G06F 3/017

(57) ABSTRACT

The present disclosure provides a device and a method for detecting hand gestures. The device includes a housing, a wearing member adapted to be worn on a user's palm, and a sensing module. The sensing module includes a light emitting component, an electromechanical component, and a light sensor. The light emitting component is configured to emit a light beam. The electromechanical component is configured to control the light beam to be emitted towards a detection area. The light sensor is configured to receive a reflected light that corresponds to the light beam and generate an electrical signal based on the reflected light. The detection area includes a finger area on the palm. The electrical signal is used to generate an image of the finger area.

### CROSS-REFERENCE TO RELATED APPLICATION(S)

The present disclosure claims the benefit of and priority to U.S. provisional Patent Application Ser. No. 63/458,329 filed on Apr. 10, 2023, entitled “Remote Control Device Utilizing Hand Gestures for Navigation,” (hereinafter referred to as “the '329 provisional”). The disclosure of the '329 provisional is hereby incorporated fully by reference into the present disclosure.

### FIELD

The present disclosure relates to a device for detecting hand gestures, and more particularly, to a device, adapted to be worn on a palm, for detecting hand gestures and a control method thereof.

### BACKGROUND

In a virtual reality or an augmented reality experience, the movement of a user's body can be detected by a plurality of sensors and then synchronously presented in three-dimensional images of the virtual reality or augmented reality, thus bringing an immersive experience to the user. However, a user's movements that are detected by most of the sensors applied in virtual reality (VR) or augmented reality (AR) apparatus mainly include, for example, hand movements and swings.

If a user's detailed movements, such as finger gestures or palm gestures, can be further detected and synchronously presented in virtual images, a better immersive experience can be provided to the user. Currently, apparatuses that include a camera system (e.g., head-mounted devices) for detecting hand gestures may be used to detect a user's hand gestures. However, when a hand of the user moves to a position where the camera cannot capture the image of the hand, it is difficult for the head-mounted devices to accurately determine the gesture of the user's hand. Therefore, there is room for improvement in regards to the design of a device for detecting hand gestures and a method for detecting effective hand gestures.

### SUMMARY

In view of the above, the present disclosure provides a device, adapted to be worn on a palm, and a method for detecting hand gestures, and images and palm gestures in a finger area can be obtained by the device to obtain more accurate gesture information.

A first aspect of the present disclosure provides a device for detecting hand gestures. The device includes a housing, a wearing member, and a sensing module. The housing has a bottom portion and at least one side surface, and the at least one side surface has at least one opening. The wearing member is fixed to the bottom portion and adapted to be worn on a palm of a user. The sensing module is disposed within the housing and includes a light emitting component, an electromechanical component, and a light sensor. The light emitting component is configured to emit a light beam through the at least one opening. The electromechanical component is configured to control the light beam to be emitted towards a detection area including a finger area on the palm. The light sensor is electrically connected to the processor and configured to receive a reflected light that corresponds to the light beam through the at least one opening and generate an electrical signal based on the reflected light. The electrical signal is used to generate an image of the finger area.

In some implementations of the first aspect, the sensing module further includes a processor and a wireless communication module. The processor is configured to generate the image of the finger area based on the electrical signal, and the wireless communication module is electrically connected to the processor and configured to transmit the image of the finger area to a computing device.

In some implementations of the first aspect, the sensing module further includes a processor and a wireless communication module. The processor is configured to receive the electrical signal, and the wireless communication module is electrically connected to the processor and configured to transmit the electrical signal to a computing device and cause the computing device to generate the image of the finger area based on the electrical signal.

In some implementations of the first aspect, the processor is configured to determine a finger gesture based on the image.

In some implementations of the first aspect, the device further includes a motion sensor coupled to the processor and configured to obtain gesture data of the palm. The gesture data include at least one of orientation data, speed data, and acceleration data of the palm.

In some implementations of the first aspect, the electromechanical component includes a micro-electro-mechanical system (MEMS) mirror to reflect the light beam and adjust the direction of the light beam.

In some implementations of the first aspect, the processor is further configured to determine hand gesture information based on the image of the finger area and the gesture data of the palm.

A second aspect of the present disclosure provides a device, adapted to be worn on a palm of a user, for detecting hand gestures. The device for detecting hand gesture includes a light emitting component, an electromechanical component and a light sensor. The method for detecting hand gesture includes: emitting, by a light emitting component, a light beam; controlling, by an electromechanical component, the light beam to be emitted towards a detection area, wherein the detection area includes a finger area on a palm; receiving, by a light sensor, a reflected light that corresponds to the light beam and generating an electrical signal based on the reflected light; and generating an image of the finger area based on the electrical signal.

In some implementations of the second aspect, the method further includes determining a finger gesture based on the image.

In some implementations of the second aspect, the electromechanical component includes a micro-electro-mechanical system (MEMS) mirror, and controlling the light beam to be emitted towards the detection area includes controlling a MEMS mirror to adjust a reflection direction of the light beam.

In some implementations of the second aspect, the device for detecting hand gestures further includes a motion sensor, and the method for detecting hand gestures further includes: providing, by the motion sensor, gesture data of a palm. The gesture data include at least one of orientation data, speed data, and acceleration data of the palm.

In some implementations of the second aspect, the method further includes determining hand gesture information based on the image of the finger area and the gesture data of the palm.

### BRIEF DESCRIPTION OF THE DRAWINGS

FIG. 1 is a perspective schematic view of a device for detecting hand gestures according to an implementation of the present disclosure.

FIG. 2 is an exploded view of the device for detecting hand gestures according to an implementation of the present disclosure.

FIG. 3 is a schematic view of the device, worn on a user's palm, for detecting hand gestures according to an implementation of the present disclosure.

FIG. 4 is a schematic block diagram of the device for detecting hand gestures according to an implementation of the present disclosure.

FIG. 5 is a schematic block diagram of the device for detecting hand gestures according to an implementation of the present disclosure.

FIGS. 6A, 6B, 6C, and 6D are schematic views illustrating images of a finger area according to an implementation of the present disclosure.

FIG. 7 is a schematic block diagram of a motion sensor according to an implementation of the present disclosure.

FIG. 8 is a flowchart of a method for detecting hand gestures according to an implementation of the present disclosure.

### DETAILED DESCRIPTION

The follow description contains specific information pertaining to exemplary implementations of the present disclosure. The drawings and the accompanying detailed description of the present disclosure are merely exemplary implementations. However, the present disclosure is not limited to such exemplary implementations. Other variations and implementations of the present disclosure will occur to those skilled in the art. Unless noted otherwise, like or corresponding component among the drawings may be indicated by like or corresponding reference numerals. Furthermore, the drawings and illustrations in the present disclosure are generally not drawn to scale and are not intended to correspond to actual relative dimensions.

For purposes of consistency and ease of understanding, like features are labeled with reference numerals in the exemplary drawings (although, in some examples, not illustrated). However, the features in different implementations may differ in other respects, and thus shall not be narrowly limited to the features illustrated in the drawings.

Reference to “at least one implementation,” “an implementation,” “implementations,” “different implementations,” “some implementations,” “the present implementation,” and the like may indicate that the implementation of the present disclosure so described may include a particular feature, structure, or characteristic, but not every possible implementation of the present disclosure must include the particular feature, structure, or characteristic. Further, the repeated use of the phrases “in one implementation” or “in the present implementation” does not necessarily refer to the same implementation, although they may be. Furthermore, any use of phrases like “an implementation” in connection with “the present disclosure” does not imply that all implementations of the present disclosure must include a particular feature, structure, or characteristic, and should instead be understood to mean that “at least some implementations of the present disclosure” includes the particular feature, structure, or characteristic described. The term “coupled” is defined as connected, whether directly or indirectly through intervening components, and is not necessarily limited to physical connections. The term “comprises,” “includes,” “comprising,” or “including,” when used, means “including, but not limited to,” and specifically indicates open-ended inclusion or relationship of the described combination, group, series and the equivalent.

In addition, for purposes of explanation and not limitation, specific details such as functional entities, techniques, protocols, standards, and the like are set forth in order to provide an understanding of the described technology. In other examples, detailed descriptions of well-known methods, techniques, systems, architectures, and the like are omitted so as not to obscure the description with unnecessary details.

The terms “first,” “second,” “third,” and the like in the description of the present disclosure and the accompanying drawings are used for distinguishing different objects and not used for describing a particular order. Furthermore, that term “comprises,” “includes,” “comprising,” “including,” and any variations thereof, are intended to cover a non-exclusive inclusion. For example, a process, method, system, article, or apparatus that includes a series of steps or modules is not limited to the listed steps or modules but may alternatively include other steps or modules not listed or inherent to such process, method, article, or apparatus.

Generally, a device for detecting hand gestures in a virtual reality or an augmented reality can adopt a head-mounted device, which includes a camera system to track and determine a user's hand gestures. However, when the hand of the user moves to a position where the camera lens cannot capture the image, it is difficult for the head-mounted device to accurately determine the gesture of the user. In addition, when the user's hand performs certain action, the camera may be unable to detect the hand gesture. The reason may be that when the hand is turned over, the finger may be obscured by the palm due to a shooting angle of the camera, thus making the camera unable to detect the hand gesture, or when the hand is turned over too fast, the speed of the hand may exceed the detection limit of the camera, thus making the camera unable to detect and return image information to the head-mounted device in time, such that no response is made for the hand gesture.

In addition, the effective determination of the user's gesture may include palm gesture and finger image to facilitate accurate interpretation of the hand gestures. However, the above-mentioned device cannot detect a gesture of the palm. Further, when the depth of field of the camera for the finger is relatively short, a finger image is likely to be blurred or out of focus. In order to deal with the above situation, there is room for improvement in the design of the lens of the camera.

Some devices for detecting gestures in a virtual reality or an augmented reality currently choose to adopt a head-mounted device, which includes multiple camera systems to track user's hand gestures. That is, those devices adopt the design of increasing the number of cameras to reduce the problem of blind spots that cameras may encounter when detecting hand gestures. However, the above-mentioned solution increases the cost of the device for detecting hand gestures and requires more computing units to analyze the image, thereby increasing the power consumption of the device. Therefore, there is room for improvement in regards to the design of a device for detecting hand gestures and a method for detecting effective hand gestures.

In the case that a device for detecting hand gestures uses an image sensor including a micro-electro-mechanical system (MEMS) mirror to provide gesture information, not only can the device provide accurate gesture interpretation, but the device can also reduce the operation load of the processor without using a camera to capture the hand gesture, thus reducing the power consumption and prolonging the service time of the device. In summary, the present disclosure provides a device and a method for detecting hand gestures, thus allowing a user to use the device for a longer time without having to worry about power consumption and interpretation accuracy of gesture information, as compared to a conventional device for detecting hand gestures.

The implementation of the present disclosure will be described below with reference to the accompanying drawings.

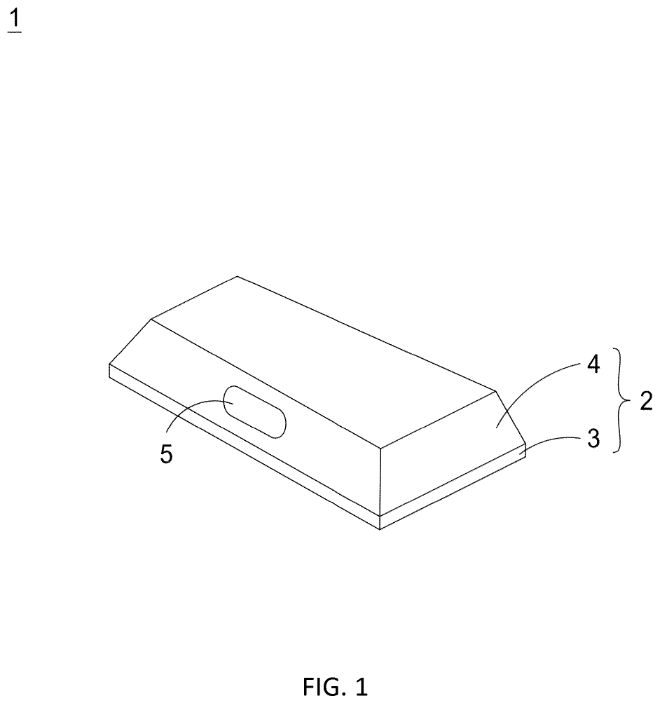

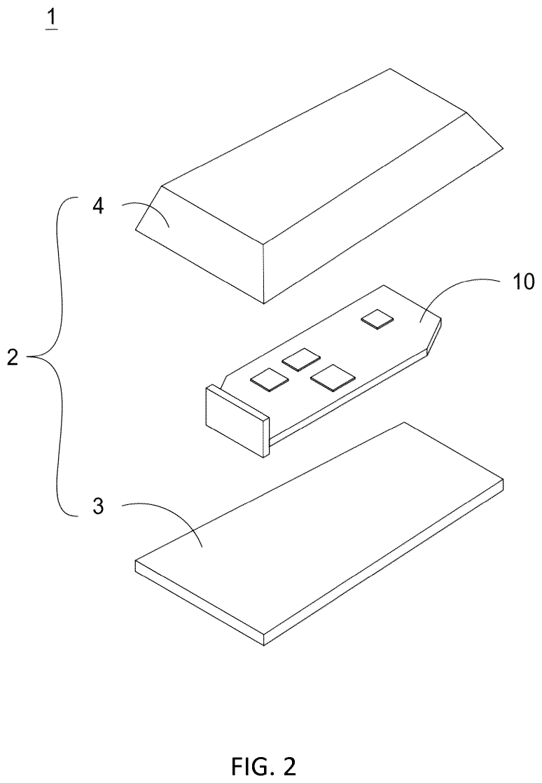

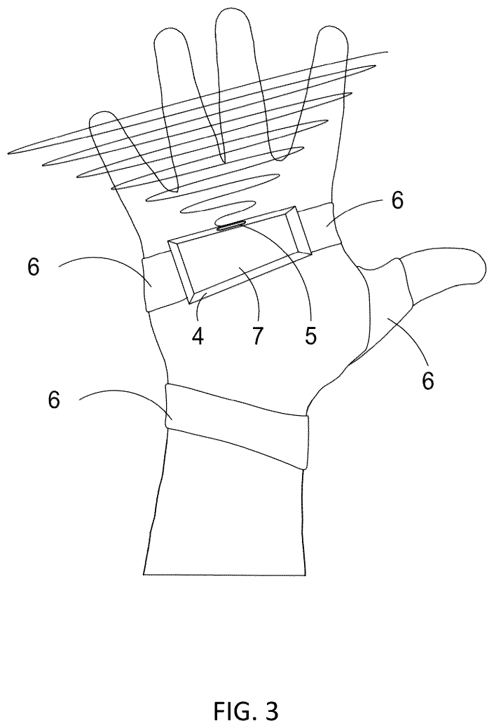

FIG. 1 is a perspective schematic view of a device for detecting hand gestures according to an implementation of the present disclosure. FIG. 2 is an exploded view of a device for detecting hand gestures according to an implementation of the present disclosure. FIG. 3 is a schematic view of a device, worn on a user's palm, for detecting hand gestures according to an implementation of the present disclosure.

Referring to FIG. 1, FIG. 2 and FIG. 3, a device 1 for detecting hand gestures is provided. In one implementation, the gesture detection device 1 includes a housing 2. The housing 2 includes a bottom portion 3 and four side surfaces 4 adjacent to the bottom portion 3, where at least one of the side surfaces 4 includes an opening 5. Please refer to FIG. 2. In one implementation, the device 1 further includes a sensing module 10. The sensing module 10 is disposed within the housing 2. Please refer to FIG. 3. In one implementation, the device 1 further includes a wearing member 6, and the wearing member 6 is fixed to the bottom portion 3 of the housing 2 and adapted to be worn on a user's palm. In one implementation, the housing 2 of the device 1 further includes an upper surface 7. However, the present disclosure is not limited to the manner in which the device 1 is worn.

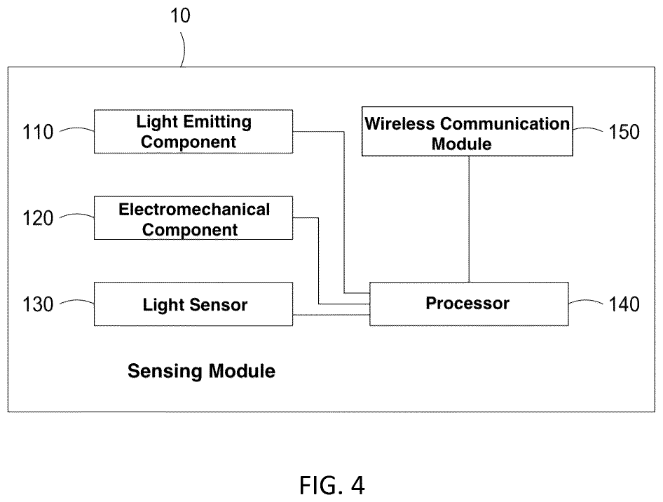

FIG. 4 is a schematic block diagram of a device for detecting hand gestures according to an implementation of the present disclosure.

In some implementations, the sensing module 10 includes a light emitting component 110, an electromechanical component 120, a light sensor 130, a processor 140, and a wireless communication module 150. The wireless communication module 150 is electrically connected to the processor 140. In addition, the light sensor 130 is electrically connected to the processor 140. The light emitting component 110 is electrically connected to the processor 140. The electromechanical component 120 is electrically connected to the processor 140.

In some implementations, the sensing module 10 generates an electrical signal for obtaining an image of a finger area. The processor 140 can generate the image of the finger area based on the electrical signal and transmit the image of the finger area to the wireless communication module 150. The image of the finger area may include the shape and gesture of the finger. The wireless communication module 150 may receive the image of the finger area from the processor 140 and transmit the image of the finger area to a computing device.

In some implementations, the processor 140 may receive the electrical signal and transmit the electrical signal to the wireless communication module 150. The wireless communication module 150 can receive the electrical signal from the processor 140 and transmit the electrical signal to a computing device and cause the computing device to generate the image of the finger area based on the electrical signal.

In some implementations, the processor 140 may also be referred to as a controller 140. In some implementations, the processor 140 may be, for example, a central processing unit (CPU) or another programmable general purpose or special purpose microprocessor, a digital signal processor (DSP), a programmable controller, an application specific integrated circuit (ASIC), a programmable logic device (PLD), or other similar components or combinations of components.

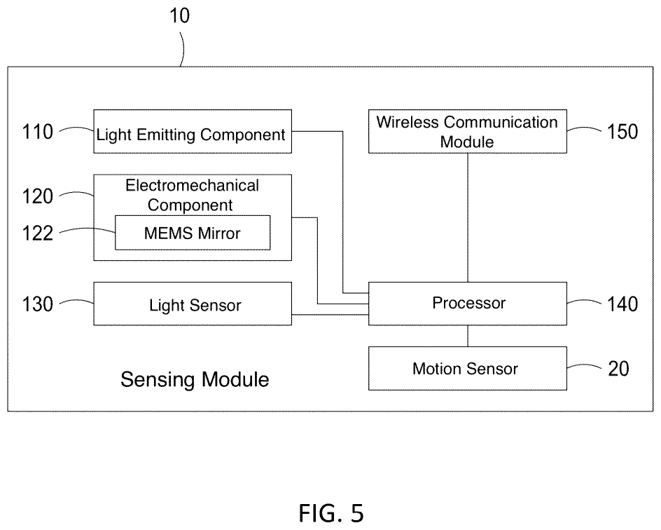

FIG. 5 is a schematic block diagram of a device for detecting hand gestures according to an implementation of the present disclosure.

In some implementations, the sensing module 10 includes a light emitting component 110, an electromechanical component 120, a light sensor 130, a motion sensor 20, a processor 140, and a wireless communication module 150. The wireless communication module 150 is electrically connected to the processor 140, the light sensor 130 is electrically connected to the processor 140, the light emitting component 110 is electrically connected to the processor 140, the electromechanical component 120 is electrically connected to the processor 140, and the motion sensor 20 is electrically connected to the processor 140.

In some implementations, since the device 1 is fixed on the user's palm, the relative position of the finger area on the user's palm with respect to the device 1 is fixed. Further, a thumb area, an index finger area, a middle finger area, a ring finger area, and a little finger area of the user can be defined in a detection area to facilitate subsequent recognition and gesture detection.

In some implementations, the light emitting component 110 is configured to emit a light beam. Referring to FIG. 1, the light emitting component 110 is configured to emit the light beam through the at least one opening 5. In some implementations, the light emitting component 110 may include, for example, an infrared laser transmitter. The infrared laser transmitter is configured to transmit an infrared laser beam. However, the present disclosure is not limited to the type of the light emitting component 110.

In some implementations, the electromechanical component 120 is configured to control the light beam to be emitted towards the detection area, which includes the finger area. The finger area includes at least one of a thumb area, an index finger area, a middle finger area, a ring finger area, and a little finger area of the user. In some implementations, the electromechanical component 120 is configured to control the light beam to scan the detection area, which includes the finger area.

In some implementations, the electromechanical component 120 is configured to control the light beam to scan the detection area, and the detection area may be further divided into a plurality of coordinate points. The electromechanical component 120 may control the light beam to scan each coordinate point in the detection area.

In some implementations, the electromechanical component 120 further includes a micro-electro-mechanical system (MEMS) mirror 122 configured to reflect the light beam emitted from the light emitting component 110 and adjust the direction of the light beam. The MEMS mirror 122 driven by a piezoelectric effect may be configured to adjust the direction of the light beam.

Referring to FIG. 3, in some implementations, the reflection direction of the light beam may cover an area to be scanned from left to right and from top to bottom in the detection area. In some implementations, the reflection direction of the light beam may cover an area to be scanned from right to left and from top to bottom in the detection area. In some implementations, the reflection direction of the light beam may cover an area to be scanned from a center of the detection area and outwards in a spiral path. In some implementations, the reflection direction of the light beam may cover an area to be scanned from an outer perimeter of the detection area and inward toward the center of the detection area in a spiral path.

In some implementations, the light sensor 130 is configured to receive the reflected light that corresponds to the light beam emitted by the light emitting component 110. Further, the reflected light received by the light sensor 130 includes corresponding reflected light that is reflected after the light beam is emitted to the finger or corresponding reflected light that is reflected after the light beam is emitted to an area excluding the finger in the detection area. The light sensor 130 is electrically connected to the processor 140.

In some implementations, the light sensor 130 is configured to receive the reflected light that corresponds to the light beam emitted by the light emitting component 110 and generate an electrical signal based on the reflected light. Then, the processor 140 generates an image of the finger area based on the electrical signal and determines a gesture of the finger based on the image.

In some implementations, the light sensor 130 is configured to receive the reflected light that is reflected from the coordinate point corresponding to the light beam that is emitted by the light emitting component 110 and generate an electrical signal indicating the coordinate point based on the reflected light reflected from the coordinate point. Then, the processor 140 generates an image of the finger area based on the electrical signals that indicate a plurality of coordinate points of the detection area.

In some implementations, when the finger is closer to the sensing module 10, for example, when the finger is bent to the palm, or when the fingers makes a clenched fist, the energy of the reflected light received by the light sensor 130 is higher. Further, the light sensor 130 generates a stronger electrical signal based on the reflected light with higher energy, and the image of the finger area corresponding to the stronger electrical signal is closer to an image that is mostly white. However, when the finger is far away from the sensing module 10, for example, when the angle between the finger and the palm is 180 degrees, the energy of the reflected light received by the light sensor 130 is lower. Further, the light sensor 130 generates a lower electrical signal based on the reflected light with lower energy, and the image of the finger area corresponding to the lower electrical signal is closer to an image that is mostly black. Therefore, the processor 140 may generate an image of the finger area based on the electrical signal, and the image of the finger area presents a finger gesture.

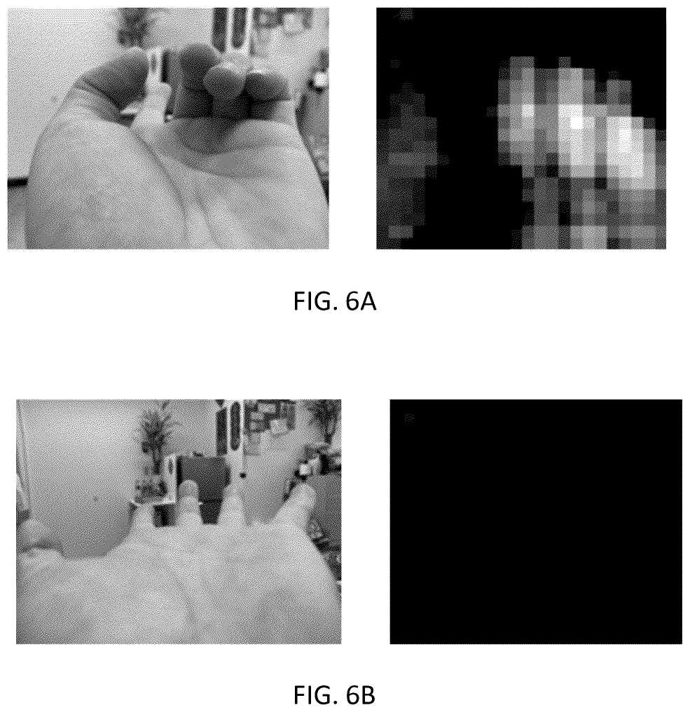

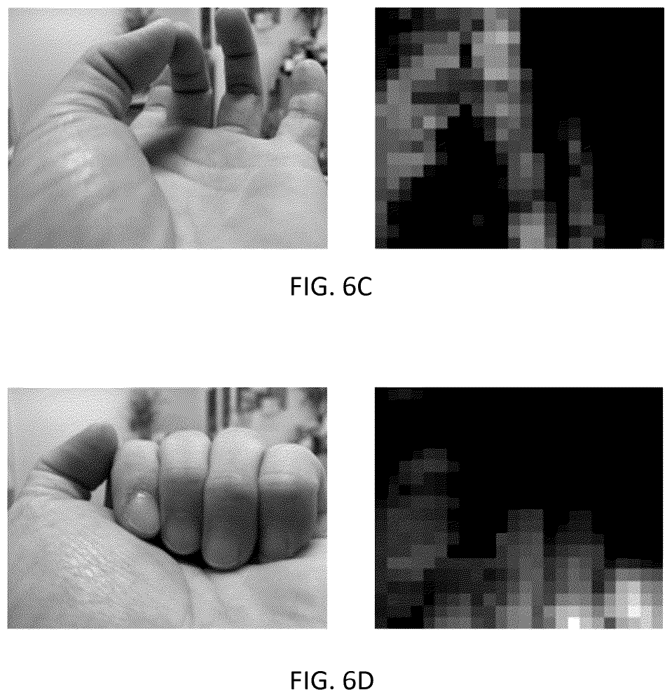

FIGS. 6A, 6B, 6C, and 6D are schematic views illustrating an image of a finger area according to an implementation of the present disclosure.

Referring to FIG. 6A, in some implementations, when the processor 140 receives the electrical signal generated by the light sensor 130, the processor 140 may generate an image of the finger area based on the electrical signal. When the electrical signal indicates that there is no reflected light energy on the index finger area while there is reflected light energy on the other four finger areas, the processor 140 may determine that the image of the finger area or the finger gesture is presenting the index finger making a pointing gesture. Referring to FIG. 6B, in some implementations, when the processor 140 receives the electrical signal that is generated by the light sensor 130, the processor 140 may generate an image of the finger area based on the electrical signal. When the electrical signal indicates that there is no reflected light energy on the five finger areas, the processor 140 may determine that the image of the finger area or the finger gesture is presenting the fingers opened with an angle, between the fingers and the palm, being 180 degrees. Referring to FIG. 6C, in some implementations, when the processor 140 receives the electrical signal that is generated by the light sensor 130, the processor 140 may generate an image of the finger area based on the electrical signal. When the electrical signal indicates that the reflected light energy of the thumb area and the middle finger area is greater than the reflected light energy of the other three finger areas, the processor 140 may determine that the image of the finger area or the finger gesture is presenting the thumb clicking the middle finger. Referring to FIG. 6D, in some implementations, when the processor 140 receives the electrical signal that is generated by the light sensor 130, the processor 140 may generate an image of the finger area based on the electrical signal. When the electrical signal indicates that a high reflected light energy is concentrated at a certain area of the detection area, the processor 140 may determine that the image of the finger area or the finger gesture is presenting the fingers making a fist gesture.

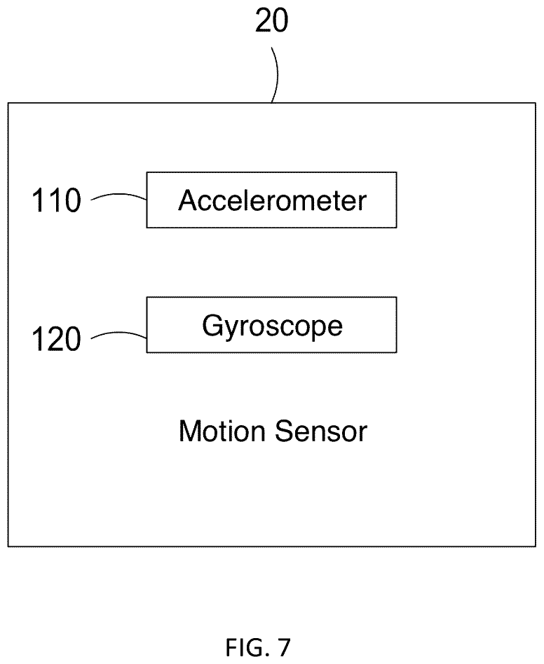

FIG. 7 is a schematic block diagram of a motion sensor according to an implementation of the present disclosure.

In some implementations, the motion sensor 20 is configured to obtain gesture data of the palm. The gesture data include at least one of orientation data, speed data, and acceleration data of the palm.

In some implementations, the motion sensor 20 includes an accelerometer 110 and a gyroscope 120. The motion sensor 20 may obtain information of six degrees of freedom (6 DoF). The accelerometer 110 is configured to measure the acceleration of the palm as it moves. For example, the acceleration of the palm may be generated by a change in the direction or speed of movement of the palm. The gyroscope 120 is configured to measure a direction of movement of the palm or a change in the speed of rotation of the palm, or the like.

In some implementations, the motion sensor 20 includes an accelerometer 110, a gyroscope 120, and a magnetic sensor (not shown). The magnetic sensor is configured to detect the change of the surrounding magnetic field environment when the palm moves. Further, the motion sensor 200 including the accelerometer 110, the gyroscope 120 and the magnetic sensor may be configured to obtain information of nine degrees of freedom (9 DoF) of the palm.

In some implementations, the motion sensor 20 is configured to obtain gesture data of the palm. The gesture data of the palm may include data of position of the palm, data of direction of the palm, and data of rotation angle of the palm with respect to a reference coordinate system. Further, the gesture data of the palm may include data of position and direction of the palm in a three-dimensional space and data of movement direction, e.g., up, down, left, right, and the like, of the palm.

Referring to FIG. 5, in some implementations, the sensing module 10 is configured to obtain an image of the finger area, and the motion sensor 20 of the sensing module 10 is configured to obtain gesture data of the palm. In some implementations, the electromechanical component 120 of the sensing module 10 is configured to control the light beam to scan the detection area. Further, the detection area includes the finger area. The light sensor 130 is configured to receive the reflected light that corresponds to the light beam emitted by the light emitting component 110 and generate an electrical signal based on the reflected light. The processor 140 determines the gesture information, based on the electrical signal that is associated with the finger area and the gesture data of the palm. Further, the gesture information includes static gesture information and dynamic gesture information, for example, a gesture characteristic of the palm, a bending characteristic of the finger, a contact characteristic of the finger, a relative position characteristic of the finger, a motion range size of the finger, a motion speed of the palm or the finger, a motion position of the palm, a motion direction of the palm, a motion starting point of the palm, or a motion ending point of the palm.

In some implementations, the static gesture information is a gesture made by a hand while in a fixed position, typically used to convey a particular message or command. For example, a “thumbs-up” gesture indicates approval or consent while a “palm-out stop” gesture indicates stop or pause. The dynamic gesture information relates to movements or motions made by the hand to convey a message or command. For example, a wave of the hand indicates hello or goodbye, or a pointing gesture indicates direct attention or indicates a particular object or location.

In some implementations, the electromechanical component 120 of the sensing module 10 is configured to control the light beam to scan the detection area. Further, the detection area includes the finger area. The light sensor 130 is configured to receive the reflected light that corresponds to the light beam emitted by the light emitting component 110 and generate an electrical signal based on the reflected light. The motion sensor 20 is configured to obtain gesture data of the palm. The sensing module 10 may further include a storage module (not shown) configured to store a gesture detection algorithm. The gesture detection algorithm includes a data comparison algorithm or an image analysis algorithm. The processor 140 is configured to determine the gesture information based on the gesture detection algorithm, the image of the finger area, and the gesture data of the palm.

In one implementation, the processor 140 is configured to determine and analyze, based on a gesture detection algorithm, whether any object in the finger area enters at least one of the thumb area, the index finger area, the middle finger area, the ring finger area, and the little finger area of the user, and then determine a finger gesture of the thumb, the index finger, the middle finger, the ring finger and the little finger of the user based on the determination and analysis that at least one object in the finger area enters the thumb area, the index finger area, the middle finger area, the ring finger area, and the little finger area of the user. In one implementation, the storage module may further include a machine learning model. The processor 140 may determine the finger gesture based on the machine learning model and the image of the finger area.

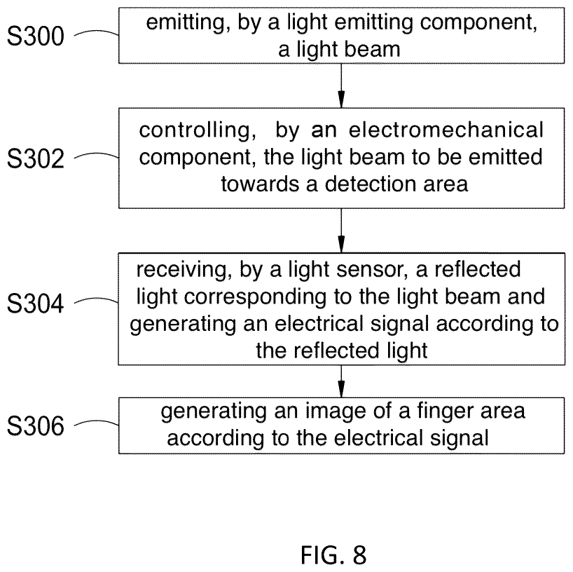

FIG. 8 is a flowchart of a method for detecting hand gestures according to an implementation of the present disclosure. In some implementations, the method of FIG. 8 is applicable to the device 1. Therefore, the method of the implementation of the present disclosure will be described below in conjunction with the components of the device 1. It should be noted, however, that the present disclosure is not limited to the device to which the method is applied.

Referring to FIG. 5, in some implementations, the device 1 includes an image sensing device 10 and a motion sensor 20. The image sensing device 10 further includes a light source 110, an electromechanical system 120, and a light sensor 130.

Referring to FIG. 8, in step 300, the light emitting component 110 emits a light beam.

In some implementations, the light emitting component 110 of the image sensing device 10 is configured to emit a light beam. In some implementations, the light emitting component 110 may include, for example, an infrared laser transmitter.

Referring to FIG. 8, in step 302, an electromechanical component is used to control the light beam to be emitted towards the detection area.

In some implementations, since the device 1 is fixed on the user's palm, the relative position of the finger area on the user's palm with respect to the device 1 is fixed. Further, a thumb area, an index finger area, a middle finger area, a ring finger area, and a little finger area of the user can be defined in the finger area.

In some implementations, the electromechanical component 120 is configured to control the light beam to be emitted towards the detection area, and the detection area may be divided into a plurality of coordinate points. The electromechanical component 120 may control the light beam to scan each coordinate point in the detection area.

In some implementations, the electromechanical component 120 includes a micro-electro-mechanical system (MEMS) mirror 122, and the electromechanical component 120 is configured to control the light beam to be emitted towards the detection area. In other words, the electromechanical component 120 may control the light beam to scan the detection area. The detection area includes a finger area, and the finger area includes at least one of a thumb area, an index finger area, a middle finger area, a ring finger area, and a little finger area of the user.

In some implementations, the electromechanical component 120 controls the MEMS mirror 122 to adjust the reflection direction of the light beam. The MEMS mirror 122 driven by a piezoelectric effect may be configured to adjust the direction of the light beam.

In some implementations, the reflection direction of the light beam may cover an area to be scanned from left to right and from top to bottom in the detection area. In some implementations, the reflection direction of the light beam may cover an area to be scanned from right to left and from top to bottom in the detection area. In some implementations, the reflection direction of the light beam may cover an area to be scanned from a center of the detection area and outwards in a spiral path. In some implementations, the reflection direction of the light beam may cover an area to be scanned from an outer perimeter of the detection area and inward toward the center of the detection area in a spiral path.

Referring to FIG. 8, in step 304, a light sensor is used to receive a reflected light that corresponds to the light beam, and an electrical signal is generated based on the reflected light.

In some implementations, the light sensor 130 is configured to receive the reflected light that corresponds to the light beam emitted by the light emitting component 110. Further, the reflected light received by the light sensor 130 includes corresponding reflected light that is reflected after the light beam is emitted to the finger or corresponding reflected light that is reflected after the light beam is emitted to an area excluding the finger in the detection area.

Referring to FIG. 8, in step 306, an image of the finger area is generated based on the electrical signal.

In some implementations, the processor 140 may generate an image of the finger area based on the reflected light detected by the light sensor 130.

In some implementations, the light sensor 130 is configured to receive the reflected light that corresponds to the light beam emitted by the light emitting component 110 and generate an electrical signal based on the reflected light. Then, the processor 140 may generate an image of the finger area based on the electrical signal and determines a gesture of the finger based on the image.

In some implementations, the light sensor 130 is configured to receive the reflected light reflected from the coordinate point that corresponds to the light beam emitted by the light emitting component 110 and generate an electrical signal that indicates the coordinate point based on the reflected light that is reflected from the coordinate point. Then, the processor 140 generates an image of the finger area based on the electrical signals that indicate a plurality of coordinate points of the detection area.

In some implementations, when the finger is closer to the sensing module 10, for example, when the finger is bent to the palm, or when the fingers makes a clenched fist, the energy of the reflected light received by the light sensor 130 is higher. Further, the light sensor 130 generates a stronger electrical signal based on the reflected light with higher energy, and the image of the finger area corresponding to the stronger electrical signal is closer to an image that is mostly white. However, when the finger is far away from the sensing module 10, for example, when the angle between the finger and the palm is 180 degrees, the energy of the reflected light received by the light sensor 130 is lower. Further, the light sensor 130 generates a lower electrical signal based on the reflected light with lower energy, and the image of the finger area corresponding to the lower electrical signal is closer to an image that is mostly black. Therefore, the processor 140 may generate an image of the finger area based on the electrical signal, and the image of the finger area may present a finger gesture.

In some implementations, when the processor 140 receives the electrical signal that is generated by the light sensor 130, if the electrical signal indicates that there is no reflected light energy on the index finger area while there is reflected light energy on the other four finger areas, then the processor 140 may determine that the image of the finger area or the finger gesture is presenting the index finger making a pointing gesture. In some implementations, when the processor 140 receives the electrical signal that is generated by the light sensor 130, and if the electrical signal indicates that there is no reflected light energy on all the five finger areas, then the processor 140 can determine the image of the finger area or the finger gesture is presenting the fingers opened with an angle, between the fingers and the palm, being 180 degrees. In some implementations, when the processor 140 receives the electrical signal that is generated by the light sensor 130, and if the electrical signal indicates that the reflected light energy of the thumb area and the middle finger area is greater than the reflected light energy of the other three finger areas, the processor 140 may determine that the image of the finger area or the finger gesture is presenting the thumb clicking the middle finger. In some implementations, when the processor 140 receives the electrical signal that is generated by the light sensor 130, and if the electrical signal indicates that a high reflected light energy is concentrated at a certain area of the detection area, the processor 140 may determine that the image of the finger area or the finger gesture is presenting the fingers making a fist gesture.

In some implementations, the device 1 further includes a motion sensor 20. The method for the device for detecting hand gesture further includes obtaining gesture data of the palm by the motion sensor 20. The gesture data include at least one of orientation data, speed data, and acceleration data of the palm.

In some implementations, the motion sensor 20 includes an accelerometer 110 and a gyroscope 120. The motion sensor 20 may obtain information of six degrees of freedom (6 DoF). The accelerometer 110 is configured to measure the acceleration of the palm as it moves. For example, the acceleration of the palm may be generated by a change in the direction or speed of movement of the palm. The gyroscope 120 is configured to measure a direction of movement of the palm or a change in the speed of rotation of the palm, or the like.

In some implementations, the motion sensor 20 includes an accelerometer 110, a gyroscope 120, and a magnetic sensor (not shown). The magnetic sensor is configured to detect the change of the surrounding magnetic field environment when the palm moves. Further, the motion sensor 200 including the accelerometer 110, the gyroscope 120 and the magnetic sensor may be configured to obtain information of nine degrees of freedom (9 DoF) of the palm.

In some implementations, the method for the device for detecting hand gesture further includes determining gesture information based on the image of the finger area and the palm gesture.

Referring to FIG. 5, in some implementations, the sensing module 10 is configured to obtain an image of the finger area, and the motion sensor 20 of the sensing module 10 is configured to obtain gesture data of the palm. In some implementations, the electromechanical component 120 of the sensing module 10 is configured to control the light beam to scan the detection area. Further, the detection area includes the finger area. The light sensor 130 is configured to receive the reflected light that corresponds to the light beam emitted by the light emitting component 110 and generate an electrical signal based on the reflected light. The processor 140 determines the gesture information based on the electrical signal that is associated with the finger area and the gesture data of the palm. Further, the gesture information includes static gesture information and dynamic gesture information, for example, a gesture characteristic of the palm, a bending characteristic of the finger, a contact characteristic of the finger, a relative position characteristic of the finger, a motion range size of the finger or the palm, a motion speed of the palm or the finger, a motion position of the palm, a motion direction of the palm, a motion starting point of the palm, or a motion ending point of the palm.

In some implementations, the static gesture information is a gesture made by a hand while in a fixed position, typically used to convey a particular message or command. For example, a “thumbs-up” gesture indicates approval or consent while a “palm-out stop” gesture indicates stop or pause. The dynamic gesture information relates to movements or motions made by the hand to convey a message or command. For example, a wave of the hand indicates hello or goodbye, or a pointing gesture indicates direct attention or indicates a particular object or location.

In some implementations, the electromechanical component 120 of the sensing module 10 is configured to control the light beam to scan the detection area, and the light sensor 130 is configured to receive a reflected light that corresponds to the light beam emitted by the light emitting component 110 and generate an electrical signal based on the reflected light. The motion sensor 20 is configured to obtain gesture data of the palm. The sensing module 10 may further include a storage module (not shown) configured to store a gesture detection algorithm. The gesture detection algorithm includes a data comparison algorithm or an image analysis algorithm. The processor 140 is configured to determine the gesture information based on the gesture detection algorithm, the image of the finger area, and the gesture data of the palm.

In one implementation, the processor 140 is configured to determine and analyze, based on a gesture detection algorithm, whether any object in the finger area enters at least one of the thumb area, the index finger area, the middle finger area, the ring finger area, and the little finger area of the user, and then determine a finger gesture of the thumb, the index finger, the middle finger, the ring finger, and the little finger of the user based on the determination and analysis that at least one object in the finger area enters the thumb area, the index finger area, the middle finger area, the ring finger area, and the little finger area of the user. In one implementation, the storage module may further include a machine learning model. The processor 140 may determine the finger gesture based on the machine learning model and the image of the finger area.

In summary, the device, adapted to be worn on a palm, and the method for detecting hand gestures provided by the implementations of the present disclosure may obtain the image of the finger area and the palm gesture to obtain more accurate gesture information.

From the above description, it should be apparent that various techniques may be used to implement the concepts described in the present application without departing from the scope of these concepts. Moreover, although concepts have been described with specific reference to certain implementations, a person of ordinary skill in the art will recognize that changes may be made in form and detail without departing from the scope of the concepts. Therefore, the described implementations are to be considered in all respects as illustrative and not restrictive. Moreover, it should be understood that the present application is not limited to the particular implementations described above, and various rearrangements, modifications and substitutions can be made without departing from the scope of the disclosure.

What is claimed is:

1. A device for detecting hand gesture, comprising:
a housing having a bottom portion and at least one side surface, wherein the at least one side surface has at least one opening;
a wearing member fixed to the bottom portion and adapted to be worn on a palm of a user; and
a sensing module disposed within the housing and comprising:
a light emitting component configured to emit a light beam through the at least one opening;
an electromechanical component configured to control the light beam to be emitted towards a detection area, wherein the detection area includes a finger area on the palm; and
a light sensor configured to receive, through the at least one opening, a reflected light corresponding to the light beam and generate an electrical signal based on the reflected light, wherein the electrical signal is used to generate an image of the finger area.

2. The device of claim 1, wherein the sensing module further comprises:
a processor configured to generate the image of the finger area based on the electrical signal; and
a wireless communication module electrically connected to the processor and configured to transmit the image of the finger area to a computing device.

3. The device of claim 1, wherein the sensing module further comprises:
a processor configured to receive the electrical signal; and
a wireless communication module electrically connected to the processor and configured to transmit the electrical signal to a computing device and cause the computing device to generate the image of the finger area based on the electrical signal.

4. The device of claim 1, wherein the electromechanical component includes a micro-electro-mechanical system (MEMS) mirror to reflect the light beam and adjust a direction of the light beam.

5. The device of claim 1, further comprising:
a processor; and
a motion sensor coupled to the processor and configured to provide gesture data of the palm, wherein the gesture data include at least one of orientation data, speed data, and acceleration data of the palm;
wherein the processor is configured to determine gesture information based on the image of the finger area and the gesture data of the palm.

6. A method, applicable to a device adapted to be worn on a palm of a user, for detecting hand gesture, the device comprising a light emitting component, an electromechanical component, and a light sensor, the method comprising:
emitting, by the light emitting component, a light beam;
controlling, by the electromechanical component, the light beam to be emitted towards a detection area, wherein the detection area comprises a finger area on the palm;
receiving, by the light sensor, a reflected light corresponding to the light beam and generating an electrical signal based on the reflected light; and
generating an image of the finger area based on the electrical signal.

7. The method of claim 6, further comprising:
determining a finger gesture based on the image.

8. The method of claim 6, wherein the electromechanical component includes a micro-electro-mechanical system (MEMS) mirror, and controlling the light beam to be emitted towards the detection area comprises:
controlling the MEMS mirror to adjust a reflection direction of the light beam.

9. The method of claim 6, wherein the device further comprises a motion sensor, and the method further comprises:
obtaining, by the motion sensor, gesture data of the palm, wherein the gesture data include at least one of orientation data, speed data, and acceleration data of the palm.

10. The method of claim 9, further comprising:
determining gesture information based on the image of the finger area and the gesture data of the palm.
